(19) United States
(12) Patent Application Publication
(10) Pub. No.: US 2011/0005619 A1
(43) Pub. Date: Jan. 13, 2011

(54) WATER FAUCET DEVICE

(75) Inventors: Hiroshi KANEMARU, Fukuoka (JP); Kenichi AOYAGI, Fukuoka (JP); Masato YAMAHIGASHI, Fukuoka (JP); Masateru MIYAZAKI, Fukuoka (JP); Tsuyoshi MIURA, Fukuoka (JP)

Correspondence Address: Studebaker & Brackett PC, One Fountain Square, 11911 Freedom Drive, Suite 750, Reston, VA, 20190, US

(73) Assignee: TOTO LTD., Fukuoka (JP)

(21) Appl. No.: 12/886,116

(22) Filed: Sep. 20, 2010

Related U.S. Application Data
(63) Continuation of application No. PCT/JP2009/056103, filed on Mar. 26, 2009.

(30) Foreign Application Priority Data
Mar. 27, 2008 (JP) 2008-084127

(51) Int. Cl. F16K 37/00

(52) U.S. Cl. 137/551

(57) ABSTRACT

To provide a water faucet device capable of easy grasp of setting states, without enlarging the size of the display portion. The present invention is a water faucet device (1) furnished with a flow setting function or temperature setting function; whereby the water faucet device has an operating portion (6) for controlling the water faucet device; a spout portion (2) forming a water discharge port; a light injecting portion (42), disposed at the base of the spout portion or the operating portion so as to be adjacent to the attaching surface at which the spout portion or the control portion are attached, for shining light onto the attaching surface; and display means (26) for displaying flow setting values or temperature setting values by varying the illumination range (46) formed on the attaching surface by the light illuminated from the light injecting portion.

### TECHNICAL FIELD

The present invention relates to a water faucet device, and more particularly to a water faucet device furnished with a flow setting function or a temperature setting function.

### BACKGROUND ART

Utility Model H04-17651 (Patent Document 1) discloses a spouting water faucet. This spouting water faucet is constituted so that switching between spouting and stopping water, flow quantity adjustment, and spouted water temperature adjustment is controlled by pushbutton switches. Furthermore, this spouting water faucet is provided with lamps for indicating the respective states of adjustment to small, appropriate, and large flows, and to low temperature, appropriate temperature, and high temperature settings, and displays setting states by illuminating those lamps in accordance with the setting state.

Laid Open Unexamined Patent Publication 2001-123485 discloses a faucet apparatus with an LED. This water faucet apparatus is constituted so that a plurality of LEDs are disposed on the side of the body thereof; the color of injected light is changed by switching these LEDs to cause them to emit light, and the spouted water temperature is displayed by changes in the emitted color.

### Patent Document 1

Utility Model H04-17651

### Patent Document 2

Laid Open Unexamined Patent Publication 2001-123485

### DISCLOSURE OF THE INVENTION

### Problems the Invention is to Resolve

However, in the spouting water faucet set forth in Utility Model H04-17651, lamps must be provided in a number equal to the number of setting states the spouting water faucet is capable of assuming, therefore a large number of lamps must be disposed if there is a desire to display a variety of setting states, leading to the problem of enlargement of the spouting water faucet. The problem can also arise that because many display lamps are provided on a compact spouting water faucet, each display portion is reduced in size, making it difficult to see the display.

In the water faucet apparatus set forth in Laid Open Unexamined Patent Publication 2001-123485, the color emitted by the water faucet apparatus emission of light displays the setting state, therefore the display portion is not increased in size even if the number of displayed states increases. However, because the setting state is displayed by color hue, the problem arises that it is difficult for a user to directly perceive the setting state. In other words, it is difficult for the user to accurately perceive what temperature the color of light emitted from the water faucet apparatus corresponds to.

Therefore the present invention has the object of providing a water faucet device enabling easy perception of setting states, without enlarging the size of the display portion.

### Means for Solving the Problem

To solve the aforementioned problem, the present invention is a water faucet device furnished with a flow setting function or temperature setting function, comprising: an operating portion for operating the water faucet device; a spout portion forming a water discharge port; a light injecting portion, disposed at the base of the spout portion or the operating portion so as to be adjacent to an attaching surface at which the spout portion or the operating portion are attached, for shining light onto the attaching surface; and display means for displaying flow setting values or temperature setting values by varying the illumination range formed on the attaching surface by the light illuminated from the light injecting portion.

In the present invention thus constituted, an indentation is provided at the base portion of the spout portion adjacent to the attaching surface to which the spout portion is attached, or an indentation is provided at the base portion of the operating portion adjacent to the attaching surface to which the operating portion is attached. The light injecting portion disposed within this indentation shines light on the attaching surface, and a light-illumination range is formed by this injected light. The display means displays flow setting values or temperature setting values by varying the illumination range formed on the attaching surface.

In the present invention thus constituted, a flow setting value or temperature setting value are displayed by varying the light illumination range formed on the attaching surface, therefore the setting state can be easily perceived without enlarging the display portion.

The present invention is a water faucet device capable of jetting warm water, comprising: an operating portion for operating the water faucet device; a spout portion forming a water discharge port; temperature detection means for detecting the temperature of warm water jetted from the water discharge port; a light injecting portion, disposed at the base of the spout portion or the operating portion so as to be adjacent to an attaching surface at which the spout portion or the operating portion are attached, for shining light onto the attaching surface; display means for displaying temperatures detected by the temperature detection means by varying the illumination range formed on the attaching surface by the light illuminated from the light injecting portion.

In the present invention thus constituted, an indentation is provided at the base portion of the spout portion, adjacent to the attaching surface to which the spout portion is attached, or an indentation is provided at the base portion of the operating portion, adjacent to the attaching surface to which the operating portion is attached. The light injecting portion disposed within this indentation shines light on the attaching surface, and a light-illumination range is formed by this injected light. The display means displays temperatures detected by temperature detection means by varying the illumination range formed on the attaching surface.

In the present invention thus constituted, temperatures detected by temperature detection means are displayed, therefore the setting state can be easily perceived without enlarging the display portion.

In the present invention, an indentation is preferably formed at the base end portion of the spout portion or the operating portion so as to be adjacent to the attachment surface thereof, and the light injecting portion is disposed within the indentation.

In the present invention thus constituted, the light injecting portion is disposed inside the indentation formed at the base end portion of the spout portion or the operating portion, making it difficult for light from the light injection portion to directly impinge on a user's eyes; the light illumination range formed on the attaching surface is what primarily enters the users eyes, and the visual appeal of the water faucet device is thereby improved.

In the present invention, the light illumination range is preferably formed around the spout portion or the operating portion, and the size of the light illumination range is changed in a concentric circular form.

In the present invention thus constituted, the light illumination range is formed around the spout portion or the operating portion, therefore users can perceive displayed values from any direction.

In the present invention, the light injection portion preferably has a light conducting member for conducting light from a light source to an attachment surface.

In the present invention thus constituted, light from a light source is conducted by a light conducting member therefore the light source can be placed in any desired position.

In the present invention, the light injection portion preferably has a reflecting member for conducting light from a light source to an attachment surface.

In the present invention thus constituted, light from a light source is reflected and conducted by a reflecting member therefore the light source can be placed in any desired position.

In the present invention, the display means, when commencing the injection of light from a state in which light from the light injecting portion is extinguished, preferably temporarily expands the light illumination range to a maximum size, then forms a light illumination range of a size corresponding to the value to be displayed.

In the present invention thus constituted, when commencing the injection of light, the light illumination range is temporarily expanded to a maximum size, then given a size corresponding to the value to be displayed, therefore the user can easily perceive the level of the displayed value within the entire range thereof.

### EFFECT OF THE INVENTION

Using the water faucet device of the present invention, setting states can be easily perceived without enlarging the size of the display portion.

### BEST MODE FOR PRACTICING THE INVENTION

Next, referring to the attached figures, we discuss embodiments of the present invention.

First, referring to FIGS. 1 through 5, we discuss a water faucet device according to a first embodiment of the present invention. FIG. 1 is a perspective diagram depicting a water faucet device according to the present embodiment. FIG. 2 is a block diagram depicting the constitution of the water faucet functional portion of a water faucet device according to the present embodiment. FIG. 1 is a sectional view depicting a water faucet device control portion according to the present embodiment. In addition, FIG. 4 is a time chart depicting the action of the water faucet device in the present embodiment.

As shown in FIG. 1, a water faucet device 1 according to a first embodiment of the present embodiment comprises a water faucet main unit 2 serving as a spout portion on which a water spouting port 2a is provided; an operating portion 6 attached to a sink counter 8; and a water faucet function portion 10 disposed at the lower side of the sink counter 8 on which a sink bowl 4 is disposed.

In the water faucet device 1 of the present embodiment, an electrical signal is sent to the water faucet function portion 10 by operating the operating portion 6. In other words, by pushing the operating portion 6, the water faucet device 1 can switch between spouting and stopping water from the water faucet main unit 2 water spouting port 2a and control the spouted flow thereof, and by rotating the operating portion 6, can adjust the spouted water temperature. That is, the water faucet device 1 of the present embodiment enables switching between spouting water and stopping water as well as the functions of adjusting flow and temperature.

As shown in FIG. 2, the water faucet function portion 10 has a temperature adjustment valve 12 connected to a hot water supply pipe 12a and a cold water supply pipe 12b; three electromagnetic valves 14, 16, and 18 and three fixed flow valves 20, 22, and 24 respectively connected between each of the electromagnetic values and the water faucet main unit 2; a controller 26 for controlling the temperature adjustment valve 12 and each of the electromagnetic valves; and a temperature sensor 28 serving as a temperature detecting means for measuring the temperature of spouted hot water.

Connected in parallel to the outlet pipe path of the temperature adjustment valve 12 are three electromagnetic valves: a low-flow electromagnetic valve 14, a medium-flow electromagnetic valve 16, and a high-flow electromagnetic valve 18. Furthermore, fixed flow valves are respectively connected in series on the outlet side of each electromagnetic valve. That is, a low-flow fixed flow valve 20 is connected to the outlet side of the low-flow electromagnetic valve 14; a medium-flow fixed flow valve 22 is connected to the outlet side of the medium-flow electromagnetic valve 16, and a high-flow fixed flow valve 24 is connected to the outlet side of the high-flow electromagnetic valve 18. Furthermore, the outlet sides of each of the fixed flow valves are merged and connected to the water faucet main unit 2.

By this constitution, when the low-flow electromagnetic valve 14 is released, hot water flowing from the temperature adjustment valve 12 flows through the low-flow electromagnetic valve 14 into the low-flow fixed flow valve 20; flow volume is here restricted to a certain small flow, and is spouted from the water faucet main unit 2 water spouting port 2a. Similarly, when the medium-flow electromagnetic valve 16 is released, hot water flows through the medium-flow electromagnetic valve 16 and into the medium-flow fixed flow valve 22; flow volume is here restricted to a predetermined medium flow; when the high-flow electromagnetic valve 18 is released, hot water flows through the high-flow electromagnetic valve 18 and into the high-flow fixed flow valve 24; flow volume is here restricted to a certain large flow, and is spouted from the water faucet main unit 2 water spouting port 2a.

The temperature adjustment valve 12 is constituted so that hot water flowing in from a hot water supply pipe 12a and cold water flowing in from a cold water supply pipe 12b are mixed together according to a temperature setting and caused to flow out. In the present invention, a thermovalve of the type which adjusts temperature using the biasing force of a shape memory alloy spring and a biasing spring to drive a main valve body is used as the temperature adjustment valve 12. The setting temperature of the hot water spouted from the temperature adjustment valve 12 can be changed by driving a motor 12c coupled to the temperature adjustment valve 12.

A controller 26 sends a signal to each of the electromagnetic valves and temperature adjustment valves 12 based on an electrical signal input from the operating portion 6, thereby controlling these valves. Specifically, the controller 26 comprises such items as an input interface for inputting signals from the operating portion 6; a memory serving as memory means for storing control programs, set temperatures, set flow volumes, and the like; a microprocessor for executing programs; and an output interface for driving each of the electromagnetic valves and temperature adjustment valves (not shown). Details of the control executed by the controller 26 are described below.

A temperature sensor 28 is disposed in each pipeline downstream of the part at which the hot water from each of the fixed flow valves converges, and measures the temperature of hot water spouted from the water spouting port 2a.

As shown in FIG. 3, the operating portion 6 is attached to the sink counter 8 serving as the attachment surface for the operating portion; it has an operating handle 30, an operating portion main unit portion 32, and a rotation and pressing detection device 34 built into the operating portion main unit portion 32. Furthermore, the operating portion 6 has a rotating base plate 36 disposed within it; an LED 38 serving as a plurality of light sources, mounted on this rotating base plate 36; a cover member 40 covering the rotating base plate 36; and a light guide member 42 serving as light injection portion, for guiding light from the LED 38 serving as light source.

The operating handle 30 has a circular plate portion 30a which is gripped and pressed by a user; and a shaft portion 30b protruding rearward from the reverse side center of the circular plate portion 30a. Furthermore, a side wall portion 30c extending toward the sink counter 8 is formed on the outside perimeter of the circular plate portion 30a, and the rotating base plate 36, the cover member 40, and the like are housed at the rear surface side of the circular plate portion 30a, inside this side wall portion 30c. There is a gap between the bottom end of the side wall portion 30c and the top surface of the sink counter 8; this gap enables the formation of an indentation 30d at the base end portion of the operating portion 6 so as to be adjacent to the sink counter 8.

The operating portion main unit portion 32 is an approximately cylindrical member; the axial portion 30b of the operating handle 30 extends along the center axis line thereof, and within it is stored the rotation and pressing detection device 34. A flange portion 32a extending outward is formed at the top portion of the operating portion main unit portion 32. In addition, a male screw is formed at the outer perimeter lower portion of the operating portion main unit portion 32; engaged on this male screw is an operating portion affixing member 44. The operating portion 6 is affixed to the sink counter 8 by the sandwiching of the sink counter 8 between the flange portion 32a and the operating portion affixing member 44.

The rotation and pressing detection device 34 is furnished with a spindle 34a protruding from the center thereof; the tip of this spindle 34a is coupled to the tip of the operating handle 30 axial portion 30b. The spindle 34a is disposed to be able to rotate and press in relative to the rotation and pressing detection device 34 device main unit 34b, so as to detect rotation and pressing of the operating handle 30. When the operating handle 30 is pressed, the spindle 34a is pushed into the device main unit 34b; when the pressing force ceases to act upon it, it then is pushed back out to its original position. When the rotation and pressing detection device 34 detects a rotation or pressing operation, a signal of that detection is sent to the controller 26.

The operating portion may also be constituted so that the operating handle is barely pushed in even if a user applies a pressing force. In such cases, the pressing operation can be detected by a pressure sensor or the like. Note that the present Specification includes as pressing operations both the operation in which an operating handle is pushed in by a users pressing force, and the operation in which the operating handle is barely pushed in.

A circuit board 36 is formed in an approximately donut shape, and is disposed to extend approximately parallel to the sink counter 8. A plurality of LEDs 38 is mounted in a circle of the surface of the side of the circuit board 36 facing the sink counter 8. Lead wires 36a connected to the controller 26 extend from the circuit board 36; electrical power to illuminate the LED 38 is supplied via these lead wires 36a.

A cover member 40 has a disk portion 40a and a cylinder portion 40b extending rearward from the center of this disk portion 40a and disposed concentrically to the operating handle 30. The cylinder portion 40b is received inside the operating portion main unit portion 32, and the axial portion 30b of the operating handle 30 extends so as to penetrate through the cylinder portion 40b. The disk portion 40a extends up to the inner circumferential surface of the operating handle 30 side wall portion 30c, covering the circuit board 36. A seal member 40c is disposed between the outside circumference of the disk portion 40a and the inside circumference of the side wall portion 30c, and assures water-tightness between the operating handle 30 and the cover member 40.

The light guide member 42 is a donut-shaped light guiding flat plate; it is disposed parallel to the sink counter 8 at the top surface of the operating portion main unit portion 32 flange portion 32a. THE plate surface of the light guide member 42 is thus positioned to face each of the LEDs 38 mounted on the circuit board 36. Light injected from each LED 38 propagates from the plate surface of the light guide member 42 across the inside portion thereof by interface reflection, and is then injected in a radial direction from the light guide member 42 external perimeter end surface 42a. Light injected from each LED 38 is therefore radially injected from the operating portion 6 based end indentation 30d. Note that to raise the propagation ratio of light within the light guide member 42, it is desirable to surface treat the center-side inner surfaces and the top and bottom surfaces of the light guide member 42 (excluding the incident surface facing the LED 38) to make them reflective, and to make contacting surfaces out of mirror material or the like.

The controller 26 controls each of the electromagnetic valves and temperature adjustment valves 12 based on electrical signals from the operating portion 6, spouting the set volume and temperature of hot water, while also causing the LED 38 built into the operating portion 6 to emit light, thereby functioning as a display means to display the volume of spouted water. Therefore the display means is implemented by the microprocessor or the like which forms the controller 26.

The display means built into the controller 26 changes the brightness of each of the LEDs 38 built into the operating portion 6 according to the spouted flow volume. In other words, when flow volume is low, brightness is made low, when flow volume is medium, brightness is made medium, and when flow volume is high, brightness is made high. The intensity of light injected from the LED 38, made incident inside the light guide member 42 from the plate surface of the light guide member 42, and injected from the external perimeter end surface 42a of the light guide member 42, is thus varied. When the intensity of light injected from the external perimeter end surface 42a of the light guide member 42 is thus varied, the range of illumination on the sink counter illuminated by this light is also varied.

Next, referring to FIGS. 4 and 5, we discuss the operation of a water faucet device according to a first embodiment of the present invention.

FIG. 4 is a timing chart, with the timing of the operating portion 6 pressing operation in the top row and the spouted water flow volume in the bottom row. FIG. 5 is a perspective view showing the state of the illumination range formed around the operating portion 6.

First, with water flow stopped at time t1, pressing the operating portion 6 operating handle 6a is detected by the rotation and pressing detection device 34 built into the operating portion 6, and a signal is sent to the controller 26. The controller 26 sends a signal to the electromagnetic valve, releasing it and commencing the spouting of water. At this point, the display means built into the controller 26 supplies power to the LED 38 built into the operating portion 6, causing it to emit light.

Light injected from the LED 38 is made incident inside the light guide member 42 from the plate surface of the light guide member 42 and injected from the external perimeter end surface 42a. Light injected from the light guide member 42 external perimeter end surface 42a is projected onto the sink counter 8 to which the operating portion 6 is attached; as shown in FIG. 5, a ring-shaped illumination range 46 is thus formed on the operating portion 6 sink counter 8. The light guide member 42 external perimeter end surface 42a is formed in a band shape in a limited range in the height direction of the base end portion of the operating portion 6 so as to project light onto the sink counter 8. Therefore in a normal usage state, light reflected by the sink counter 8 enters the user's eye over a broader range than does that in the height direction of the external perimeter end surface 42a.

Moreover, the light guide member 42 external perimeter end surface 42a on which light is injected is positioned within the indentation 30d formed at the base end portion of the operating portion 6, therefore in the normal usage state, light is ejected from the light guide member 42 with little visibility to the user's eye of the guide member 42 external perimeter end surface 42a, and light reflected by the sink counter 8 is what primarily enters the users eye.

As shown in FIG. 5, the ring-shaped light illumination range 46 is formed as a concentric circle relative to the entire perimeter of the operating portion 6; when the intensity of light injected from the light guide member 42 is low, that diameter is small as shown in FIG. 5(a); as the light intensity grows, the diameter expands, as shown in FIGS. 5(b) and (c). In other words, the change in the size of the light illumination range 46 formed on the sink counter 8 allows the user to know the setting state of the water faucet device 1, so that the sink counter 8 which serves as the attaching surface for the operating portion 6 can be made to function as a display portion.

When a switch is made at time t1 from the water stopped state to the water spouting state, the display means built into the controller 26 causes the LED 38 to output at high brightness for an instant. This causes the formation of a large diameter light illumination range 46, as shown in FIG. 5(c). Next, the display means causes the LED 38 to emit light at an intensity corresponding to the volume of water spouted. In the example shown in FIG. 4, the previous water spouting was stopped in a medium-flow state, therefore spouting commences at a medium flow, and the LED 38 emits light at a medium intensity. This causes the formation of a medium light illumination range 46, as shown in FIG. 5(b).

The display means thus causes the LED 38 to temporarily emit light at a high brightness when water spouting starts, enabling the user to easily perceive the approximate size of the spouted amount relative to the maximum flow volume when the LED 38 subsequently emits light at a brightness corresponding to the spouted water flow volume. In other words, the illumination range 46 shown in FIG. 5(b) is formed after the illumination range 46 shown in FIG. 5(c) is temporarily formed when water spouting begins, so the user can see that the current spouted water amount is less than the maximum spouted water amount.

Next, when the operating handle 6a is again pushed at time t2 in the water spouting state, and continues to be pushed in that way until time t3, the controller 26 recognizes that the operating handle 6a has been pushed for a long time. When the operating handle 6a is pushed, the controller 26 sends a signal to the high-flow electromagnetic valve 18 and releases that valve, and sends a signal to the medium-flow electromagnetic valve 16 to close that valve, thereby starting high-flow spouting. The display means causes the LED 38 to emit light at a high brightness, forming a large diameter light illumination range 46 such as that shown in FIG. 5(c). The user thus sees that the flow volume has changed to a large flow volume.

Furthermore, when the operating handle 6a is continuously pushed until time t4, the controller 26 opens the medium-flow electromagnetic valve 16 and closes the high-flow electromagnetic valve 18, thereby returning the flow volume to a medium flow. At the same time, the display means causes the LED 38 to emit light at a medium brightness, forming a medium diameter light illumination range 46 such as that shown in FIG. 5(b). The user can thus see that the flow volume has been changed to a medium-flow.

Next, when the operating handle 6a is continuously pushed until time t5, the controller 26 opens the low-flow electromagnetic valve 14 and closes the medium-flow electromagnetic valve 16, thereby returning the flow volume to a small flow. At the same time, the display means causes the LED 38 to emit light at a low brightness, forming a small diameter light illumination range 46 such as that shown in FIG. 5(a). The user can thus see that the flow volume has been changed to a small flow.

On the other hand, when the operating handle 6a is continuously pressed until time t6, the controller 26 this time changes the flow volume to a medium flow. Thus, when the operating handle 6a is continuously pushed, the controller 26 changes the flow volume so as to repeatedly increase and decrease it.

When the user stops the pressing operation at time t7, the medium-flow volume of spouted water is thereafter maintained, and emission by the LED 38 of a medium brightness light is maintained. Moreover, when a normal pressing operation (a non-lengthy pressing operation) is carried out at time t8, the controller 26 closes the medium-flow electromagnetic valve 16 and water is stopped. The display means extinguishes the LED 38.

By the same token, when the operating handle 6a is rotated, the rotation and pressing detection device 34 housed within the operating portion 6 detects that operation and sends a signal to the controller 26. The controller 26 sends a signal to the temperature adjustment valve 12, changing the set temperature in response to the rotating operation.

In the water faucet device of the first embodiment of the present invention, the flow volume setting value is displayed by the change in the illumination range formed on the sink counter, therefore users can easily perceive the flow volume setting value without enlarging the display portion.

In the faucet device of the present embodiment, the light illumination range is formed around the operating portion, therefore users can perceive displayed values from any direction.

Furthermore, in the faucet device of the present embodiment, light from the LED is directed by a light guiding member, therefore the operating portion can be reduced in size without the need for placing the LED inside the indentation.

In the faucet device of the present embodiment, the light illumination range is temporarily expanded to a maximum size when switching to the spouting state, then given a size corresponding to the value to be displayed, therefore the user can easily perceive the level of the displayed value within the entire range thereof.

Next, referring to FIG. 6, we discuss a water faucet device according to a second embodiment of the present invention. The water faucet device of the present embodiment differs from the above-described first embodiment in that the operating portion is provided on the sink bowl rather than on the sink counter. The water faucet device of the present embodiment also differs from the above-described first embodiment in that the actual spouted water temperature from the spout port is displayed according to the size of the illumination range formed around the operating portion. Therefore we discuss only those points of the present embodiment which differ from the first embodiment, and omit a discussion of points which are the same in both embodiments. FIG. 6 is a perspective view depicting a water faucet device according to the present embodiment.

As shown in FIG. 6, in the water faucet device according to the second embodiment of the present invention, the operating portion 6 is provided on the horizontal surface portion at the front right side of the sink bowl 4. Therefore in the present embodiment, the attachment surface of the operating portion 6 is the horizontal surface portion of the sink bowl 4, and an indentation 30d (FIG. 3) is formed at the base end portion of the operating portion 6 so as to be adjacent to the sink bowl 4. Light injected from the indentation 30d is projected onto the horizontal surface portion of the sink bowl 4 to form a light illumination range on this horizontal portion.

In the present embodiment, the temperature of hot water spouted from the water spouting port 2a is detected by a temperature sensor 28 (FIG. 2) provided in the pipe between en route to the water spouting port 2a, and the detected signal is sent to the controller 26. The display means built into the controller 26 changes the brightness of light emitted by the LED 38 built into the operating portion 6 based on signals detected by the temperature sensor 28. The light illumination range formed on the sink bowl 4 is thus changed and the spouted water temperature is displayed.

In the water faucet device of the second embodiment of the present invention, the temperature detected by the temperature sensor is displayed by the change in light illumination range formed on the sink bowl, therefore the user can easily perceive the temperature of the hot water being spouted without increasing the size of the display portion.

Moreover, in the above-described embodiment, the temperature detected by the temperature sensor was displayed, but as a variation, it is also possible to construct the water faucet device so that the temperature setting value is displayed by a light illumination range.

Also, in the above-described present embodiment, light from the LED is injected from the rear by a light guiding member, but a reflecting member can also be provided at the bottom of the LED in place of a light guiding member, whereby the illumination light from the LED is reflected in a radial manner diagonally downward by the reflecting member, and the attaching surface is used as the light illumination range.

In the above-described embodiment, an indentation was formed at the base end portion of the operating portion, and light was injected from this indentation, but the indentation may also be provided at the based end portion of the water faucet main unit so as to be adjacent to the attachment surface, with light injected from here. In such cases, light is injected at the attaching surface of the water faucet main unit; the light illumination range is formed here, thereby displaying the temperature setting value or flow volume setting value. Note that the operating portion and the water faucet main unit may be attached to any desired attachment surface in addition to the sink counter and the sink bowl.

In the above-described present embodiment, the light illumination range was changed by varying the LED brightness, but the light illumination range may also be varied by other methods. For example, the formed light illumination range can be varied using optics such as a lens, a prism, a light reflecting member, a light blocking member, or the like.

Furthermore, in the above-described embodiment the size of the light illumination range was varied concentrically to display the values being displayed, but the shape of the illumination range may be set as desired to a rectangle, a fan shape, or the like.

In the above-described embodiment, the display means varied the illumination range by varying the brightness of light emitted by each of the LEDs, but the water faucet device could also be constituted to vary the illumination range by increasing and decreasing the number of light sources among the multiple LED or other light sources used.

### BRIEF DESCRIPTION OF FIGURES

FIG. 1 A perspective view depicting a water faucet device according to a first embodiment of the present invention.

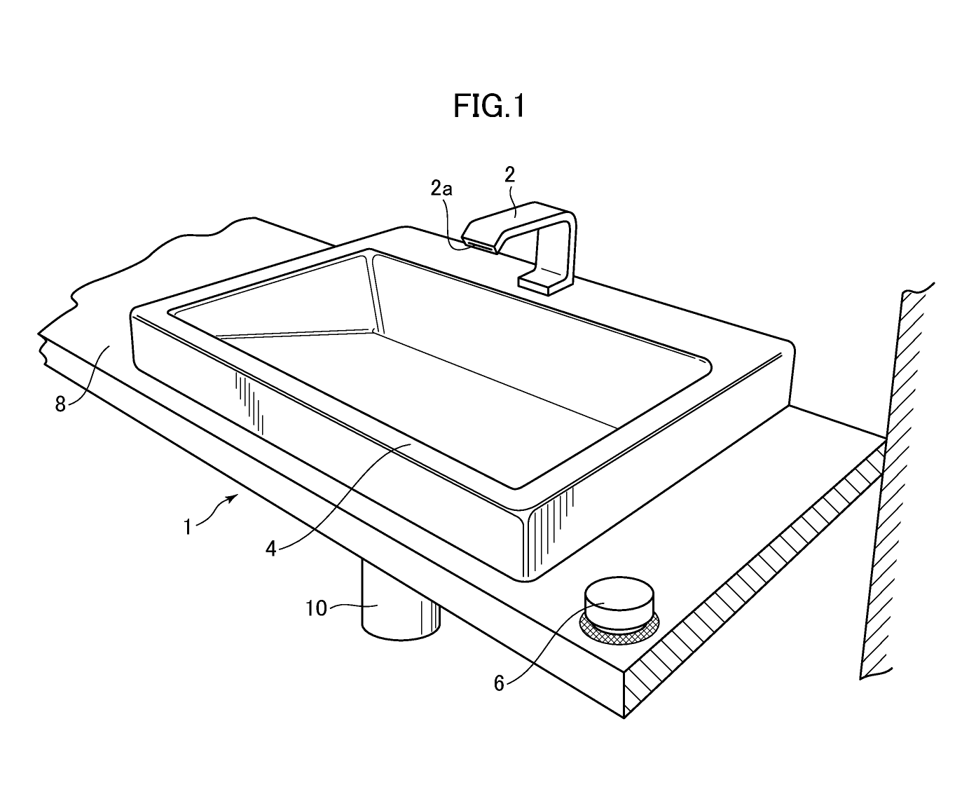

FIG. 2 A block diagram depicting the constitution of the water faucet functional portion of a water faucet device according to a first embodiment of the present invention.

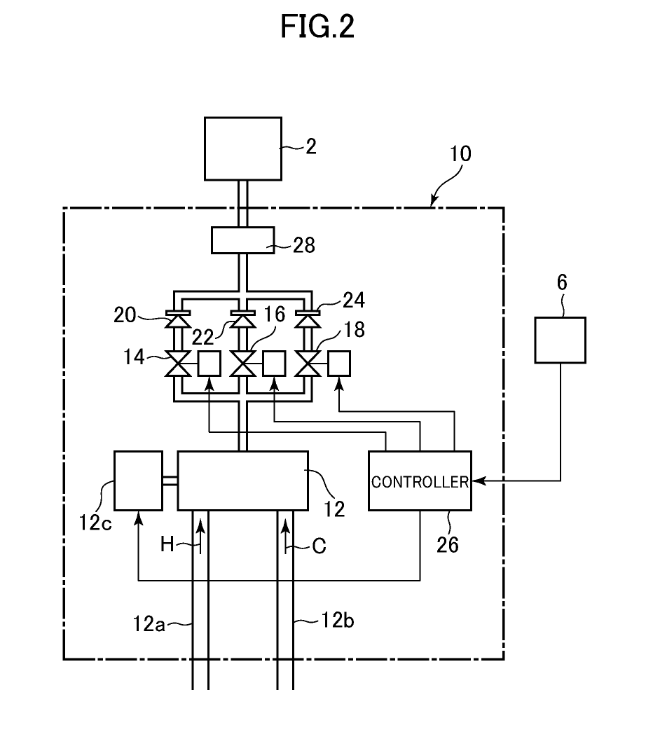

FIG. 3 A cross section depicting the operating portion of a water faucet device according to a first embodiment of the present invention.

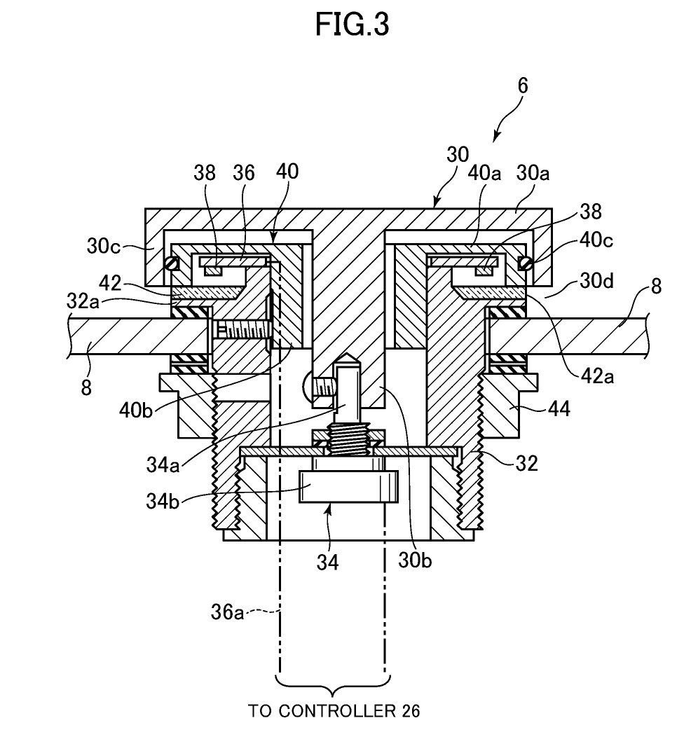

FIG. 4 A time chart depicting the action of the water faucet device in the first embodiment of the present invention.

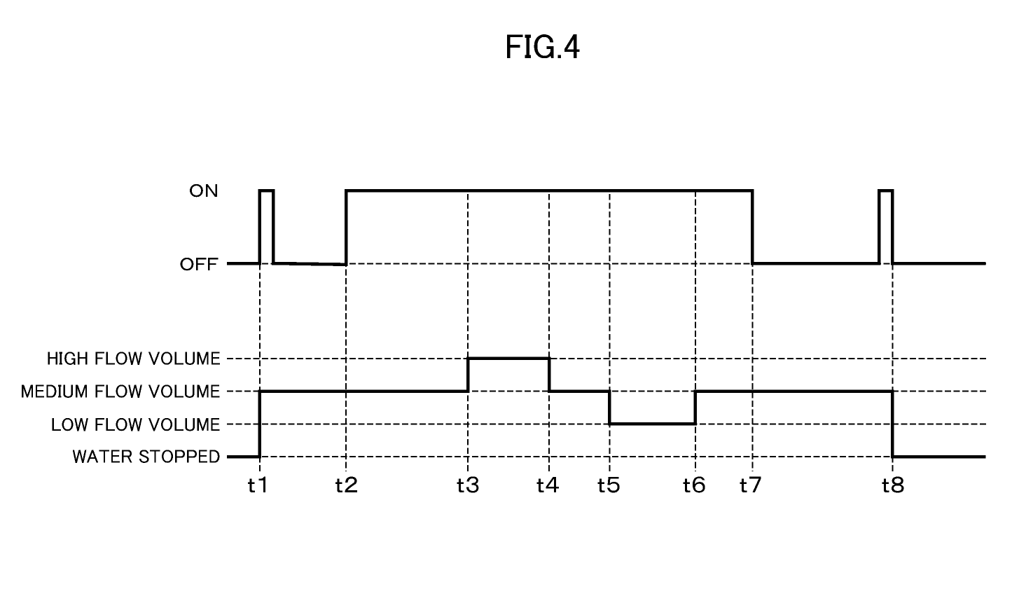

FIG. 5 A perspective view showing the state of the illumination range formed around the operating portion.

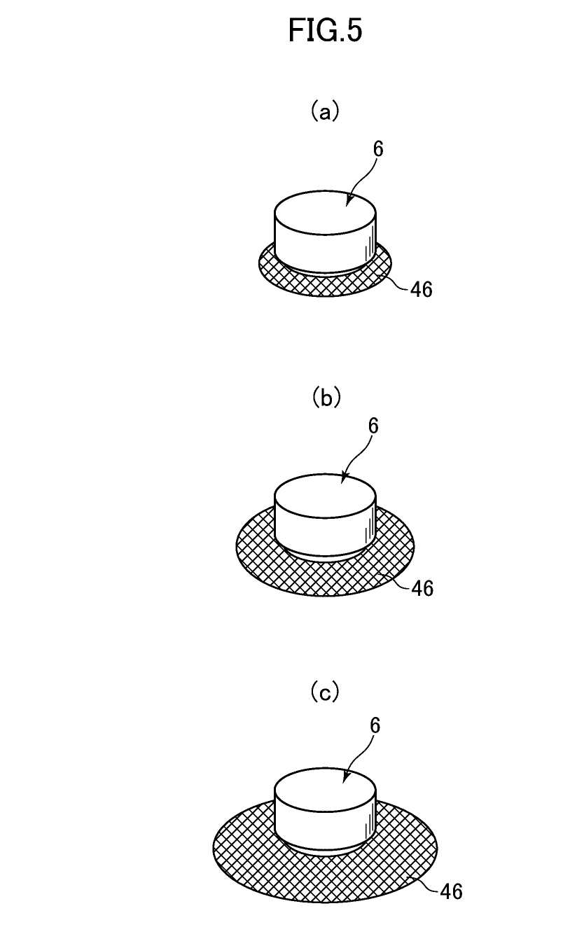

FIG. 6 A perspective view depicting a water faucet device according to a second embodiment of the present invention.

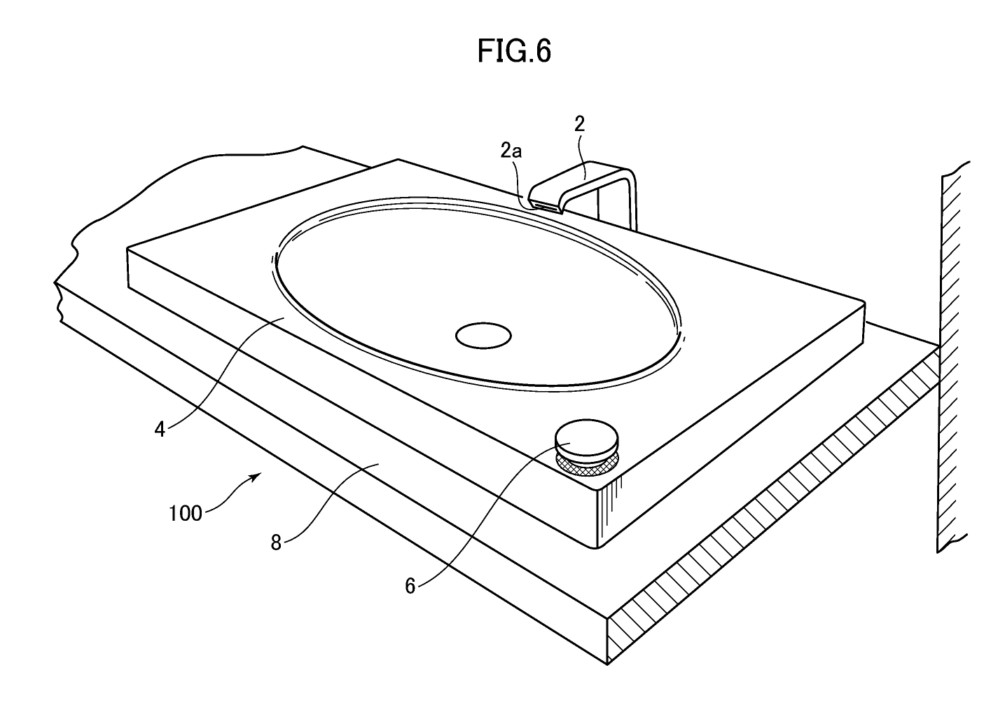

### EXPLANATION OF REFERENCE NUMERALS

1 water faucet device
2 water faucet main unit (spout portion)
2a water spouting port
4 sink bowl
6 operating portion
6a operating handle
6b operating portion main unit
6c rotation detection device
6d pressing detection device
8 sink counter
10 water faucet function portion
12 temperature adjustment valve
12a hot water supply pipe 12a
12b cold water supply pipe
14 low-flow electromagnetic valve
16 medium-flow electromagnetic valve
18 high-flow electromagnetic valve
20 low-flow fixed flow valve
22 medium-flow fixed flow valve
24 high-flow fixed flow valve
26 controller
28 temperature sensor
30 operating handle
30a circular plate portion
30b axial portion
30c side wall portion
30d indentation
32 operating portion main unit portion
32a flange portion
34 rotation and pressing detection device
34a spindle
34b device main unit
36 circuit board
36a lead wires
38 LED (light source)
40 cover member
40a disk portion
40b cylinder portion
40c seal member
42 light guide member
42a external perimeter end surface
44 operating portion affixing member
46 light illumination range
100 water faucet device

What is claimed:

1. A water faucet device furnished with a flow setting function or temperature setting function, comprising:
an operating portion for operating the water faucet device;
a spout portion forming a water discharge port;
a light injecting portion, disposed at the base of the spout portion or the operating portion so as to be adjacent to an attaching surface at which the spout portion or the operating portion are attached, for shining light onto the attaching surface; and
display means for displaying flow setting values or temperature setting values by varying the illumination range formed on the attaching surface by the light illuminated from the light injecting portion.

2. A water faucet device capable of jetting warm water, comprising:
an operating portion for operating the water faucet device;
a spout portion forming a water discharge port;
temperature detection means for detecting the temperature of warm water jetted from the water discharge port;
a light injecting portion, disposed at the base of the spout portion or the operating portion so as to be adjacent to an attaching surface at which the spout portion or the operating portion are attached, for shining light onto the attaching surface;
display means for displaying temperatures detected by the temperature detection means by varying the illumination range formed on the attaching surface by the light illuminated from the light injecting portion.

3. The water faucet device according to claim 1, wherein an indentation is formed at the base end portion of the spout portion or the operating portion so as to be adjacent to the attachment surface thereof, and the light injecting portion is disposed within the indentation.

4. The water faucet device according to claim 1, wherein the light illumination range is formed around the spout portion or the operating portion, and the size of the light illumination range is changed in a concentric circular form.

5. The water faucet device according to claim 1, wherein the light injecting portion has a light conducting member for conducting light from a light source to the attaching surface.

6. The water faucet device according to claim 1, wherein the light injecting portion has a reflecting member for conducting light from a light source to the attaching surface.

7. The water faucet device according to claim 1, wherein when commencing the injection of light from a state in which light from the light injecting portion is extinguished, the display means temporarily expands the light illumination range to a maximum size, then forms a light illumination range of a size corresponding to the value to be displayed.

8. The water faucet device according to claim 2, wherein an indentation is formed at the base end portion of the spout portion or the operating portion so as to be adjacent to the attachment surface thereof, and the light injecting portion is disposed within the indentation.

9. The water faucet device according to claim 2, wherein the light illumination range is formed around the spout portion or the operating portion, and the size of the light illumination range is changed in a concentric circular form.

10. The water faucet device according to claim 2, wherein the light injecting portion has a light conducting member for conducting light from a light source to the attaching surface.

11. The water faucet device according to claim 2, wherein the light injecting portion has a reflecting member for conducting light from a light source to the attaching surface.

12. The water faucet device according to claim 2, wherein when commencing the injection of light from a state in which light from the light injecting portion is extinguished, the display means temporarily expands the light illumination range to a maximum size, then forms a light illumination range of a size corresponding to the value to be displayed.
